(19) United States
(12) Patent Application Publication
(10) Pub. No.: US 2009/0149168 A1
(43) Pub. Date: Jun. 11, 2009

(54) System and method for disabling text message functionality

(76) Inventor: Marc Thomas McLean, Mentor, OH (US)

Correspondence Address: Marc Thomas McLean, 9356 Ivan Court, Mentor, OH, 44060, US

(21) Appl. No.: 12/313,325

(22) Filed: Nov. 19, 2008

Related U.S. Application Data
(60) Provisional application No. 60/989,317, filed on Nov. 20, 2007.

(51) Int. Cl. H04M 3/00; H04W 4/00

(52) U.S. Cl. 455/418; 455/466

(57) ABSTRACT

A system and method for disabling text message functionality is provided. The method includes, for example, determining the velocity of the text messaging capable device, comparing the velocity to a specified threshold value, disabling the text messaging functionality of the device if the velocity of the device exceeds the specified threshold, comparing the velocity of the text message enabled device after a specified time delay and enabling the text message functionality of the device if the velocity does not exceed the specified threshold.

### CROSS-REFERENCE TO RELATED APPLICATIONS

This application claims priority to U.S. Provisional Patent Application Ser. No. 60/989,317 filed on Nov. 20, 2007 and which is hereby fully incorporated by reference.

### FIELD OF INVENTION

The invention relates generally to text messaging, and more particularly, to disabling text message functionality.

Text messaging or “texting” is the common term for sending short text messages to and from portable communications devices. While text messaging provides an important communications tool, text messaging while driving an automobile can be dangerous and has been fatal.

According to one embodiment, a method of preventing text messaging while the portable communications device is in motion is provided.

### SUMMARY

According to one embodiment, a method of disabling text message functionality is provided. The method includes reading the local velocity of the portable communications device or equivalent device. This velocity is then compared to a threshold value and if the velocity is greater, the text message functionality of the device is disabled or suspended. After a specified time delay, the local velocity is again compared to a threshold value, and if the velocity is less, the text message functionality is restored.

### BRIEF DESCRIPTION OF THE DRAWINGS

FIG. 1 is a block diagram of the various embodiments of a portable communications device system.

FIG. 2 is a block diagram of a single chip cellular phone processor.

FIG. 3 is a block diagram of a single chip GPS solution.

FIG. 4 is a flow diagram of the various embodiments of disabling text messaging functionality.

### DETAILED DESCRIPTION OF ILLUSTRATED EMBODIMENTS

Prior to discussing the various embodiments, a review of the definitions of some exemplary terms used throughout the disclosure is appropriate. Both singular and plural forms of all terms fall within each meaning:

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“ROM”, as used herein, includes any read only memory. ROM may be included in a single chip processor or may be a separate integrated circuit.

“RAM”, as used herein, includes any random access memory. RAM may be included in a single chip processor or may be a separate integrated circuit.

“Portable communications device”, as used herein, may be any portable communications device, such as, but not limited to, a cellular phone, mobile phone, and/or personal digital assistant, used for mobile communication supporting, but not limited to voice, text messaging, email, and Internet access.

“Local velocity”, as used herein, is the velocity of the portable communications device.

“GPS”, as used herein, is the global positioning system, developed by the United States Department of Defense, and officially named NAVSTAR GPS or a proprietary system accomplishing the same functionality.

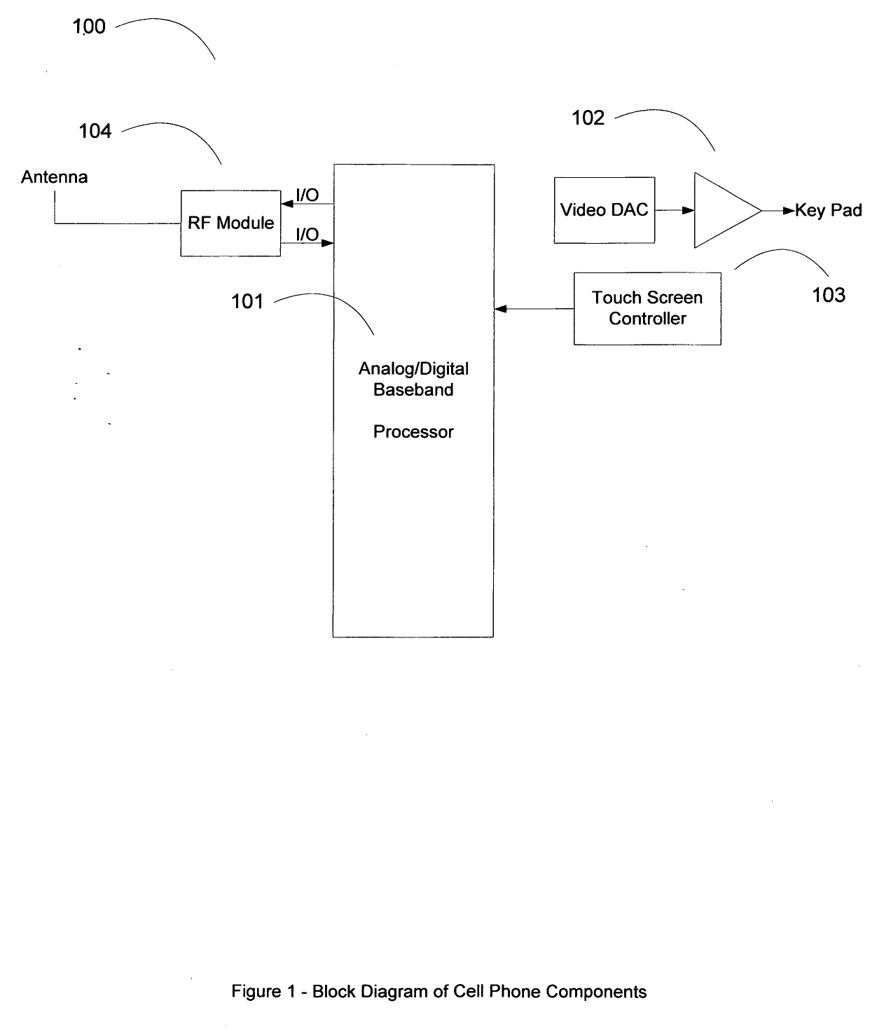

Illustrated in FIG. 1, is a block diagram of a system 100 of one embodiment of the present invention. System 100 is a cellular phone system. Shown, for illustrative purposes, are typical cellular phone system components manufactured by Texas Instruments. A cellular phone may include, but is not limited to, a main processor 101, a key pad 102, a touch screen 103, audio amplifiers, power management circuitry, various input and output ports for external signal processing and an RF module 104. Included in the main processor may be text messaging functionality.

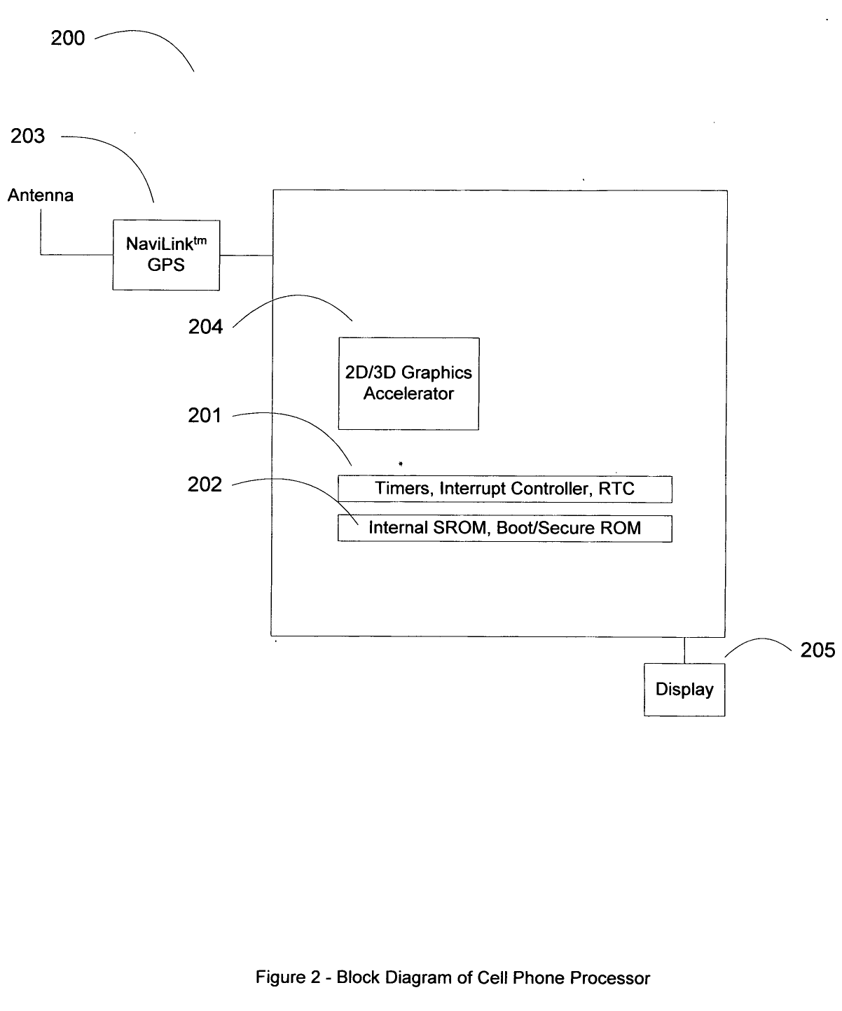

Referring now to FIG. 2, one embodiment of a block diagram of a system 200 is shown. System 200 is a single chip cellular phone processor. Shown for illustrative purposes, is a Texas Instruments single chip cellular phone processor, model OMAP2400. System 200 includes but is not limited to timers 201, ROM 202, a GPS interface 203, a graphics interface 204 and a user display 205.

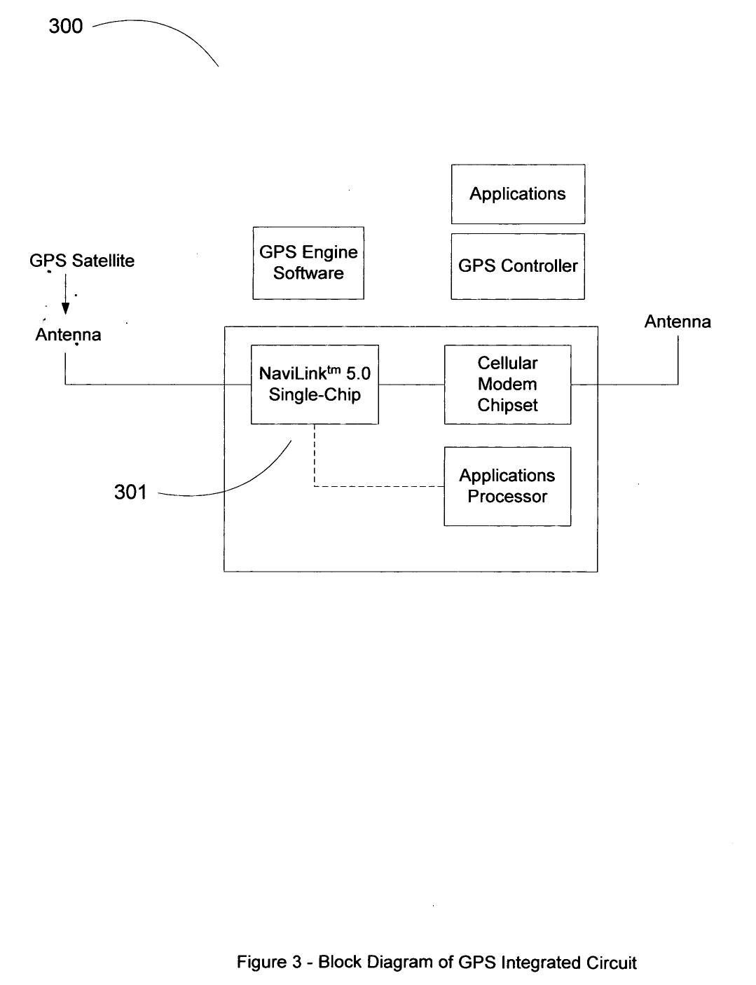

Referring now to FIG. 3, one embodiment of a block diagram of a system 300 is shown. System 300 is a RF module used in cellular phones. Shown for illustrative purposes, is a Texas Instruments single chip GPS integrated circuit, model NL5350. Included in the RF module may be a single chip GPS integrated circuit 301.

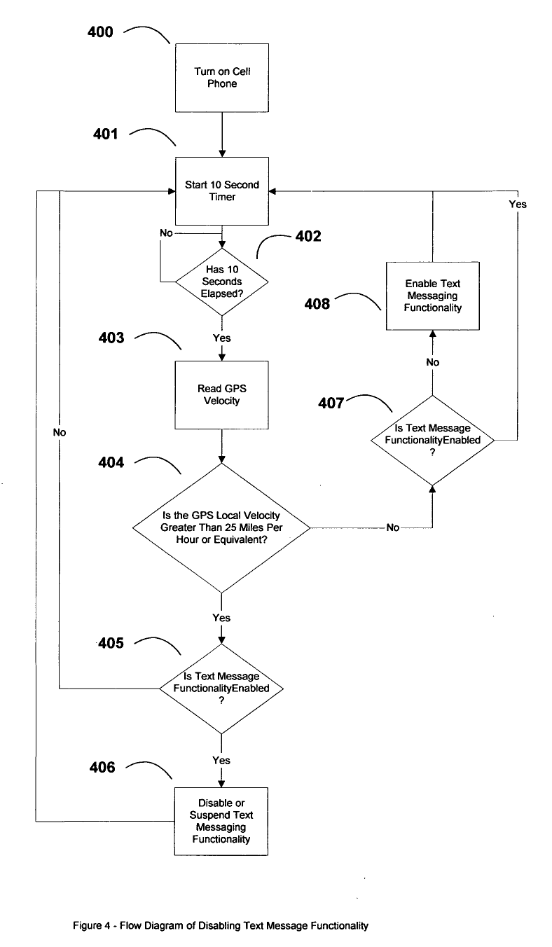

Referring now to FIG. 4, one embodiment of a flow diagram for disabling text message functionality is shown. This software may reside in ROM in 202 or in application memory in 202. After the cellular phone's power is turned on in 400, a timer is started in 401. This timer may be a software timer in RAM or ROM 202, or a hardware timer in 201. Either the software timer or hardware timer may cause a hardware interrupt in 201. In 402 a specified time elapse is tested. This time elapse can be any length practical. If the specified time has elapsed, the GPS local velocity is read from the GPS integrated circuit 301. The local velocity is compared against a specified threshold value in 404. The threshold value in 404 can be any value practical. If this threshold is exceeded, a test to determine if the text message functionality is enabled is performed in 405. If the text message functionality is currently enabled, then it is disabled in 406. If the current text message functionality is disabled as tested in 405, program execution returns to 401 where the timer is re-started. If the specified threshold is not exceeded as tested in 404, a test is performed in 407 to determine if the text message functionality is currently enabled. If the text message functionality is currently not enabled as test in 407, then it is enabled in 408. If the text message functionality as tested in 407 is currently enabled then program execution returns to 401 where the timer is re-started.

The text message disabling functionality may be disabled or enabled remotely for example by a parent or guardian of the cellular phone operator, for example over the internet.

The systems and methods of the present invention can be implemented on a variety of platforms including, for example, cellular phones, personal digital assistances, and mobile phones. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired. Additionally, the logic and process flows described herein, may be implemented entirely or in part in hardware, for example, using hardware interrupts or equivalent.

While the present invention has been illustrated by the description of embodiments thereof, and while the embodiments have been described in considerable detail, it is not the intention of the specification to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed:

1. A method of disabling text message functionality, comprising;
receiving the velocity of the text message capable device;
comparing the velocity to a specified threshold;
disabling the device's text message functionality if the velocity of the text message enabled device exceeds a specified threshold;
enabling the device's text message functionality if the velocity of the device does not exceed a specified threshold.

2. The method of claim 1 further comprising determining speed from change in position of the text message capable device over time.
